(19) United States
(12) Patent Application Publication
(10) Pub. No.: US 2005/0038563 A1
(43) Pub. Date: Feb. 17, 2005

(54) Device and method for kinematic calibration of robots

(76) Inventors: Abdul Rauf, Buk-gu (KR); Jeha Ryu, Buk-gu (KR); Jong-Phil Kim, Buk-gu (KR); Sung-Gwon Kim, Buk-gu (KR)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 10/891,261

(22) Filed: Jul. 14, 2004

(30) Foreign Application Priority Data
Aug. 16, 2003 (KR) 10-2003-0056727
Nov. 28, 2003 (KR) 10-2003-0085335

(51) Int. Cl. G06F 19/00

(52) U.S. Cl. 700/245

(57) ABSTRACT

The present invention provides a device for kinematic calibration of a robot, comprising a supporting member fixed to the base of a robot; a constraint link installed between the supporting member and an end-effector of the robot connected to the base of the robot through a plurality of movable links so as to constrain a distance between the base and the end-effector of the robot; two joints installed at the constraint link; a mean to detect angular rotation for measuring angular rotation of the end-effector when the end-effector of the robot moves to a predetermine posture; a mean to detect inclination of the constrain link installed at the constraint link about two mutually perpendicular axes for measuring inclination of the constraint link about X and Y axes; a mean to detect variation of the length for measuring variation of length of the constraint link.

### BACKGROUND OF THE INVENTION

1. Field of the Invention

The present invention is related to a device and method for kinematic calibration of robots, and more particularly, it is related to a device and method for kinematic calibration of parallel robot manipulators.

2. Description of the Prior Art

The accuracy of a robot is considered as a very important performance measure. The accuracy of robot depends on its controller and the accuracy of the geometric (kinematic) parameters that define the mathematical model of the robot in its controller. Due to factors like manufacturing tolerances, assembly errors etc., the actual geometric parameters differ from the nominal design parameters. Using the mathematical model based on the nominal parameters, therefore, results in accuracy deterioration of the robot.

Errors that deteriorate the accuracy can be divided into two categories: the geometric errors and the non-geometric errors. Errors in length of links and position of joints are the typical examples of geometric errors, whereas gear backlash and friction are the main sources of non-geometric errors. Generally, the geometric errors have higher magnitudes and dominate the overall accuracy of the robot manipulators. Therefore, it is highly required to minimize the geometric errors thereby improving the accuracy.

Kinematic calibration is a process that estimates the actual values of the geometric parameters and thus improves the accuracy of robot manipulators.

The process of kinematic calibration comprises four components: Kinematic model—defining the relationships between geometric parameters and posture (position and orientation) of a robot, Measurements—giving precise values for all or some of the posture components, Identification—minimizing certain criterion to get better estimates of the geometric parameters, and Compensation—updating the values of geometric parameters in the robot controller.

In recognition to the significance of the robot calibration, many studies have been conducted on calibration devices for serial robot manipulators as disclosed in International Publication No. WO 1998/32571 (International Application No.

PCT/JP1998/00164) and Korean Patent No. 10-0251040 based on the aforementioned calibration method. Recently, many studies on the calibration of parallel robot manipulators have also been conducted depicting the very significance of the calibration of parallel manipulators that have advantages of high rigidity, high accuracy, high load to mass ratio and the like.

The Laid-Open Korean Patent (Publication No. 2002-0084979) discloses an example of measurement device and method for calibration of parallel robot manipulators.

The measurement device for calibration, hereafter referred to as calibration device, comprises a bar (link) having Universal joints on both ends. At one end, a rotary sensor is attached that can be coupled to the end-effector for measuring end-effector rotation. At the other end, a mounting base is provided that can be attached to the base of the robot manipulator. Also mounted on the link, is a device that can measure the inclination of the link about two mutually perpendicular axes.

The method for calibrating a robot using the calibration device constructed as above comprises of four steps: a first step of installing the device between the base and the end-effector of a robot, a second step of measuring the actuators lengths and components of the end-effector's posture at different locations in workspace, a third step of establishing the minimization criterion based on the computed and the measured values, and a fourth step of obtaining calibrated geometric parameters by minimizing the criterion established in step 3 using the Least-Square techniques.

The calibration device and method have potential to estimate all geometric parameters with only partial posture measurements. Many of the existing calibration methods using partial posture measurements lack this potential, and consequently their compensation is prone to low reliability and variation of accuracy in the workspace of the robot.

### SUMMARY OF THE INVENTION

The present invention is conceived to solve the aforementioned problems. An object of the present invention is to provide a device and method for kinematic calibration of robots, wherein the robot is moved to various postures in a state where some degrees of freedom (DOF) are constrained, and the amount of compensation is determined by minimizing the errors between the values measured by the calibration device and those computed through the kinematic model.

Another object of the present investigation is to provide a calibration method, wherein automatic measurements and autonomous calibration can be made for parallel robot manipulators using the calibration device.

A device for kinematic calibration of robots according to an aspect of the present invention for achieving the objects comprises: a supporting member fixed to the base of a robot; a constraint link installed between the supporting member and the end-effector, which is connected to the base through a plurality of movable links, so as to restrain the distance between the base and the end-effector of the robot; two universal joints installed at the ends of the constraint link; a mean to measure the rotation of the end-effector; and a mean to detect inclination of the constraint link from true vertical with respect to two mutually perpendicular axes.

The device of the present invention may further comprise a length measurement mean that can measure the distance of the end-effector from base rather than restraining it to a fixed distance, while the end-effector of robot is moved to pre-determined postures.

The mean for measuring rotation of the end-effector is a rotary sensor, preferably an optical encoder sensor. The mean for measuring inclination of the constraint link from true vertical with respect to two mutually perpendicular axes is preferably a biaxial inclinometer. The mean for measuring the distance is preferably a Linear Variable Differential Transducer (LVDT). The accuracy of the device of the present invention will depend mainly on the accuracy of the instruments used to realize the device including rotary sensor, inclinometer, and LVDT and on two geometric parameters, namely, length of the constraint link and the angle between the measurement axes of the mean used to measure inclinations of the link.

A method for kinematic calibration of a robot according to another aspect of the present invention for achieving the objects comprises the steps of installing a constraint link, which has a mean to measure inclination about two axes, a mean to detect rotation of the end-effector, and two universal joints installed hereon, such that the length of the link is precisely known and the axes about which inclinations are measured are truly perpendicular, between the base and the end-effector of a robot to rigidly constrain the distance therebetween; the end-effector of the robot being capable of executing 5 DOF motions and moved to a plurality of pre-determined postures for acquiring measurement data, defining residual errors ‘E1’ for this case as the following equation:

$${E}_{1}^{i} = [ \begin{matrix}{α}_{m}^{i} - {α}_{c}^{i} \\ {β}_{m}^{i} - {β}_{c}^{i} \\ {ϕ}_{m}^{i} - {ϕ}_{c}^{i}\end{matrix} ] , E1 = [ {E}_{1}^{1} , {E}_{1}^{2} , L , {E}_{1}^{M} ]$$

where α and β refer to the inclination angles of the constraint link about the first axis (X-axis) and the second axis (Y-axis) respectively, φ is the rotation angle of the end-effector about the local z-axis, the subscripts m and c refer, respectively, to the measured and computed values, the superscript i denote the number of measurement, and M refers to the total number of measurements. The computed values of the angles α and β are obtained from the Cartesian posture components using the known length of the constraint link, which in turn are calculated from the measurements of moveable links through the internal sensors. If the residual errors ‘E1’ do not satisfy a predefined tolerance, ε, an amount of compensation for the geometric parameters is computed based on the correlations between the geometric parameters and the measured postures and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, a mean to measure the length of the constraint link, and two universal joints installed hereon, such that the length of the link is precisely known and the axes about which inclinations are measured are truly perpendicular, between the base and the end-effector of a robot to flexibly constrain the distance there between; the end-effector of the robot being capable of executing 6 DOF motions and moved to a plurality of pre-determined postures for acquiring measurement data, using residual errors ‘E1’, as discussed above, such that the computed values of the angles α and β are obtained from the Cartesian posture components using the measured length of the constraint link. If the residual errors ‘E1’ do not satisfy a predefined tolerance, ε, an amount of compensation for the geometric parameters is computed based on the correlations between the geometric parameters and the measured postures and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, and two universal joints installed hereon, such that the length of the link is precisely known and the axes about which inclinations are measured are not truly perpendicular, between the base and the end-effector of a robot to rigidly constrain the distance there between; the end-effector of the robot being capable of executing 5 DOF motions for postures where the end-effector is positioned over a virtual spherical surface and moved to a plurality of pre-determined postures for acquiring measurement data, the end-effector of the robot further being capable of executing 3 DOF motions for postures where the end-effector is constrained to a fixed position and moved to a plurality of pre-determined postures for acquiring measurement data, defining residual errors ‘E2’ and ‘E3’ for both set of measurements, respectively, as the following equations:

$${E}_{2}^{i} = [ \begin{matrix}L - {L}_{c}^{i} \\ {ϕ}_{m}^{i} - {ϕ}_{c}^{i}\end{matrix} ] , E2 = [ {E}_{2}^{1} , {E}_{2}^{2} , L , {E}_{2}^{M1} ]$$

$${E}_{3}^{i} = [ \begin{matrix}{x}^{f} - {x}_{c}^{i} \\ {y}^{f} - {y}_{c}^{i} \\ {z}^{f} - {z}_{c}^{i} \\ {ϕ}_{m}^{i} - {ϕ}_{c}^{i}\end{matrix} ] , E3 = [ {E}_{3}^{1} , {E}_{3}^{2} , L , {E}_{3}^{M2} ]$$

where L refers to the known length of the link, x, y, and z refer to the position components of the posture, the superscript f denotes the fixed components of posture, M1 refers to the total number of measurements for the first set, and M2 refers to the total number of measurements for the second set. If the residual errors ‘E2’ or ‘E3’ do not satisfy a predefined tolerance, ε, an amount of compensation for the geometric parameters is computed based on the correlations between the geometric parameters and the measured postures and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, a mean to measure length of the constraint link, and two universal joints installed hereon, such that the length of the link is precisely known and measured and the axes about which inclinations are measured are not truly perpendicular, between the base and the end-effector of a robot to flexibly constrain the distance there between; the end-effector of the robot being capable of executing 6 DOF motions for postures where the end-effector is positioned over a virtual spherical surface and moved to a plurality of pre-determined postures for acquiring measurement data, the end-effector of the robot further being capable of executing 3 DOF motions for postures where the end-effector is constrained to a fixed position and moved to a plurality of pre-determined postures for acquiring measurement data, using the residual errors ‘E3’ as defined above for postures where the end-effector is constrained to a fixed position and defining residual errors ‘E4’ for the postures where the end-effector is positioned over a virtual spherical surface as the following equations:

$${E}_{4}^{i} = [ \begin{matrix}{L}_{m}^{i} - {L}_{c}^{i} \\ {ϕ}_{m}^{i} - {ϕ}_{c}^{i}\end{matrix} ] , E4 = [ {E}_{4}^{1} , {E}_{4}^{2} , L , {E}_{4}^{M1} ]$$

where Lₘ refers to the measured length of the link. If the residual errors E4 or E3 do not satisfy a predefined tolerance, ε, an amount of compensation for the geometric parameters is computed based on the correlations between the geometric parameters and the measured postures and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, and two universal joints installed hereon, such that the length of the link is not precisely known and the axes about which inclinations are measured are not truly perpendicular, between the base and the end-effector of a robot to rigidly constrain the distance there between; the end-effector of the robot being capable of executing 5 DOF and moved to a plurality of pre-determined postures for acquiring measurement data, introducing two additional geometric parameters for the calibration device, namely, the length of the link and the angle between the inclination measurement axes, using the residual errors ‘E1’ as defined earlier. If the residual errors ‘E₁’ do not satisfy a predefined tolerance, ε, an amount of compensation for the geometric parameters of the robot and for the geometric parameters of the calibration device is computed based on the correlations between the geometric parameters and the measured postures using a constant length of the constraint link and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, a mean to measure the length of the constraint link, and two universal joints installed hereon, such that the length of the link is not precisely known and the axes about which inclinations are measured are not truly perpendicular, between the base and the end-effector of a robot to flexibly constrain the distance there between; the end-effector of the robot being capable of executing 6 DOF and moved to a plurality of pre-determined postures for acquiring measurement data, introducing two additional geometric parameters for the calibration device, namely, the length of the link and the angle between the inclination measurement axes, using the residual errors ‘E1’ as defined earlier. If the residual errors ‘E1’ do not satisfy a predefined tolerance, ε, an amount of compensation for the geometric parameters of the robot and for the geometric parameters of the calibration device is computed based on correlations between the geometric parameters and the measured postures using the measured lengths of the constraint link and calibration is performed accordingly.

A method for kinematic calibration of a robot according to yet another aspect of the present invention for achieving the objects comprises the steps of installing a constraint link, which has a mean to measure inclination about two axes, a mean to detect rotation of the end-effector, and two universal joints installed hereon, such that the length of the link is not precisely known and the axes about which inclinations are measured are not truly perpendicular, between the base and the end-effector of a robot to rigidly constrain the distance there between; the end-effector of the robot being capable of executing 5 DOF motions for postures where the end-effector is positioned over a virtual spherical surface and moved to a plurality of pre-determined postures for acquiring measurement data, the end-effector of the robot further being capable of executing 3 DOF motions for postures where the end-effector is constrained to a fixed position and moved to a plurality of pre-determined postures for acquiring measurement data, defining residual errors ‘E5’ and ‘E6’ for both set of measurements, respectively, as the following equations:

$${E}_{5}^{i} = [ \begin{matrix}{L}_{c}^{i} - {L}_{c}^{j} \\ {ϕ}_{m}^{i} - {ϕ}_{c}^{i}\end{matrix} ] , i \neq j ; E5 = [ {E}_{5}^{1} , {E}_{5}^{2} , L , {E}_{5}^{M1} ]$$

$${E}_{6}^{i} = [ \begin{matrix}{x}_{c}^{i} - {x}_{c}^{j} \\ {y}_{c}^{i} - {y}_{c}^{j} \\ {z}_{c}^{i} - {z}_{c}^{j} \\ {ϕ}_{m}^{i} - {ϕ}_{c}^{i}\end{matrix} ] , i \neq j ; E6 = [ {E}_{6}^{1} , {E}_{6}^{2} , L , {E}_{6}^{M2} ]$$

where the superscript i and j denote the number of measurements. If the residual errors ‘E5’ and (or) ‘E6’ do not satisfy a predefined tolerance, ε, an amount of compensation for the robot is computed based on the correlations between geometric parameters and the measured postures and calibration is performed accordingly.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a sectional view showing the device for kinematic calibration of a robot according to an embodiment of the present invention;

FIG. 2 is a perspective view of the device for kinematic calibration a robot according to the embodiment of the present invention;

FIG. 3 is a sectional view of the device for kinematic calibration of a robot according to another embodiment of the present invention;

FIG. 4 is a sectional view showing a state where a constraint post is included in the calibration device of the robot according to the present invention;

FIG. 5 is a flow chart illustrating a method for kinematic calibration of a robot according to an embodiment of the present invention; and

FIG. 6 is a flowchart illustrating a method for kinematic calibration of a robot according to another embodiment of the present invention.

FIG. 7 is a flowchart illustrating a method for kinematic calibration of a robot according to yet another embodiment of the present invention

### DESCRIPTION OF THE PREFERRED EMBODIMENTS

Hereinafter, preferred embodiments of the present invention will be described in detail with reference to the accompanying drawings.

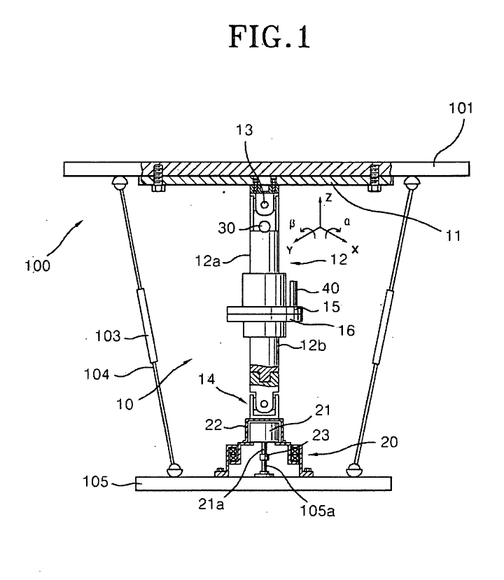

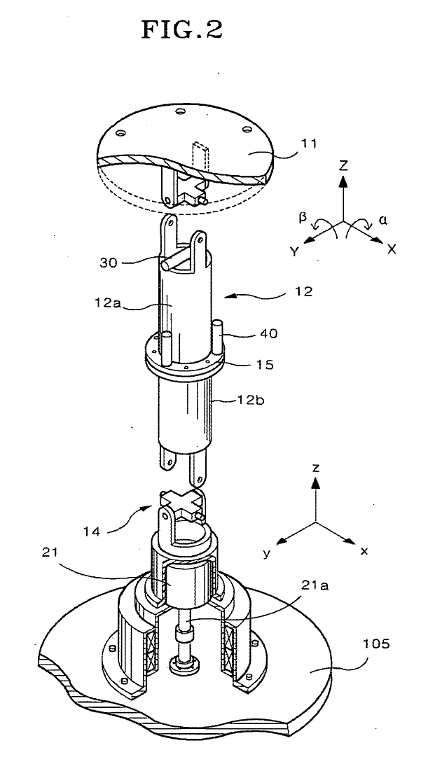

A device for kinematic calibration of a robot according to the present invention is mounted on the robot and an amount of compensation is determined by minimizing the cost function based on the difference between the measured and the computed values for position and orientation component(s) of the end-effector of the robot, where the computed values are based on the length of moveable links measured by the internal sensors and the existing values of the kinematic parameters, such that while performing measurements, the robot may be controlled in a state where some of its degrees of freedom are constrained. An embodiment of the device is shown in FIGS. 1 and 2.

Referring to these figures, the calibration device 10 has a structure capable of calibrating a robot 100 that has an end-effector 105 supported by six movable links 104 with respective actuators 103 on a base 101 fixed rigidly to a reference.

The calibration device 10 comprises a supporting member 11 attached to the base 101 of the robot, a constraint link 12 installed between supporting member 11 and the end-effector 105 and having two joints 13 and 14 installed thereon to constrain a distance between the base 101 and the end-effector 105 of the robot, a mean 20 installed on the constraint link for detecting angular rotation of the end-effector 105 of the robot when the end-effector moves to a certain posture, a mean 30 installed on the constraint link 12 to detect inclination of the constraint link 12 from vertical direction with respect to two mutually perpendicular axes; a microprocessor (not shown in Figs.) is used to control the actuators of the movable links 104 of the robot 100 and to adjust the kinematic parameters.

Universal joints are used for the joints 13 and 14, which are installed at upper and lower sides of the constraint link 12 such that they cannot interfere with the movable links 104 of the robot 100 in any posture. Here, the constraint link 12 may be divided into multiple segments so that the length thereof can be adjusted. For example, the constraint link 12 is divided into upper and lower link members 12a and 12b on which the joints 13 and 14 are installed, respectively, and opposing ends of the upper and lower link members are provided with flanges 15 and 16 for coupling.

The constraint link may further be provided with a mean to vary length of the constraint link such that the end-effector 105 is flexibly constrained and can execute 6 DOF motions. Although not shown in the figures, the mean for varying length may have a structure capable of varying the length between the flanges 15 and 16. Moreover, the constraint link 12 is further provided with a mean 40 to measure length for measuring the varied length of the constraint link. The mean to measure varied length of the end-effector may be an LVDT installed at the flange 15.

The mean for detection of angular rotation 20 employs a rotary sensor 21 that is supported by a housing 22 mounted at one end of the constraint link 12. A rotational shaft 21a of the rotary sensor 21 is connected to a rotational shaft 105a of the end-effector 105 by means of a coupling 23. The housing 22 is coupled to the end-effector 105 via a bearing to allow a relative rotation.

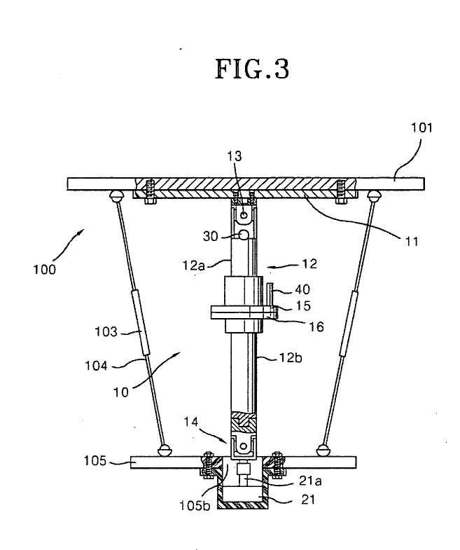

Meanwhile, as shown in FIG. 3, the rotary sensor 21 may be installed to face the constraint link 12 at the lower end of the end-effector 105 of the robot 100, and the rotational shaft 21a of the rotary sensor 21 is connected to the constraint link 12 through a through-hole 105b formed at the end-effector 105.

The installation of the rotary sensor 21 for detecting the angular rotation of the end-effector 105 is not limited to the aforementioned embodiment but may be implemented with any structures capable of measuring the angular rotation of the end-effector 105 with respect to the constraint link 12.

The mean for detection of inclination 30 can measure angular rotations of the constraint link 12 about X and Y axes. Although the mean for detection of inclination 30 is preferably installed at a position adjacent to the joint 13 located at the upper link member 12a of the constraint link 12, it is not limited thereto.

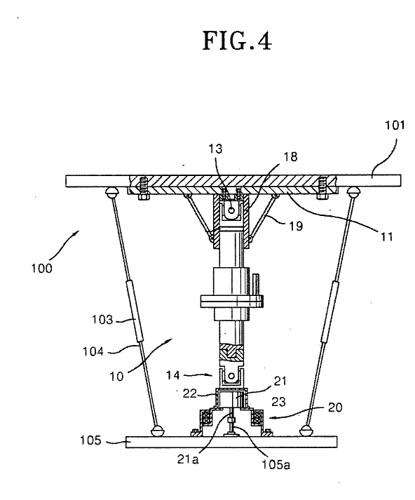

Further, as shown in FIG. 4, a portion of the upper link member 12a of the constraint link 12 on which the joint 13 is installed is coupled to and constrained by a constrained post 18. The constraint post 18 is supported by a supporting member 11 and links 19 to limit the degrees of freedom of the constraint link 12.

Now, a method for kinematic calibration of a robot using the calibration device constructed as such will be described below.

The method for kinematic calibration of the robot according to an embodiment of the present invention comprises a first step of constraining the distance between the base 101 and the end-effector 105 of the robot to constrain some degrees of freedom (DOF) of the end-effector 105 by installing the constraint link 12 between the base 101 and the end-effector 105 of the robot; a second step of moving the end-effector to a plurality of pre-determined postures for acquiring measurement data while controlling the end-effector as required and at each posture detecting the lengths of the movable links 104 installed between the base 101 and the end-effector 105 of the robot using internal sensors, the angles αₘ and βₘ of the constraint link 12 about X and Y directions using the inclination detection mean 30, and the angular rotation φₘ of the end-effector using the angular rotation detection mean 20; a third step of computing the inclination angles α_{c} and α_{c} and the angular rotation of the end-effector φ_{c} based on the positions of the movable links and the kinematic correlations of the robot, and establishing the cost function as a difference of the angles detected in the second step and the angles computed in the present step; and a fourth step of calculating the amount of compensation by minimizing the cost function established in the third step and implementing the compensation in the controller of the robot.

A calibration method according to another embodiment of the present invention comprises a first step of constraining the distance between the base 101 and the end-effector 105 of the robot to constrain some degrees of freedom (DOF) of the end-effector 105 by installing the constraint link 12 between the base 101 and the end-effector 105 of the robot; a second step of moving the end-effector to a plurality of pre-determined postures over a virtual spherical surface, while controlling the end-effector as required and at each posture detecting the lengths of the movable links 104 installed between the base 101 and the end-effector 105 of the robot using internal sensors, and the angular rotation φₘ of the end-effector using the mean for detecting angular rotation 20, moving the end-effector to a plurality of pre-determined postures retaining a fixed position of the end-effector 105, while controlling the end-effector as required and at each posture detecting the lengths of the movable links 104 installed between the base 101 and the end-effector 105 of the robot 100 using internal sensors, and the angular rotation φₘ of the end-effector using the mean for detecting angular rotation 20; a third step of computing the length of the constraint link L_{c} and angular rotation of the end-effector φ_{c} based on the positions of the movable links and the kinematic correlations of the robot for postures over virtual spherical surface, and computing the position components of the end-effector, x_{c}, y_{c}, and z_{c}, and the angular rotation of the end-effector φ_{c} based on the positions of the movable links and the kinematic correlations of the robot 100, for postures with fixed position of the end-effector 105 and establishing the cost function as a difference of the measured and the computed values; and a fourth step of calculating the amount of compensation by minimizing the cost function established in the third step and implementing the compensation in the controller of the robot.

Hereinafter, the operation of the device for kinematic calibration of the robot according to the present invention, and the method for kinematic calibration of the robot using the device will be described in greater detail.

First, a parallel robot manipulator has many independent kinematic parameters for calibration. The addition of the constraint link 12 of the calibration device according to the present invention may confine 6 DOF motions of the end-effector to 5 DOF or 3 DOF motions.

If the origin of the fixed (base) frame is located at the center of the universal joint close to the base of the robot 100 and origin of the mobile frame (end-effector) is located at the center of the universal joint close to the end-effector 105, and if L is the length of the constraint link 12 and α and β are the inclination angles of the constraint link 12 about the X and Y axes, then the position of the end-effector can be expressed as follows.
x=−L cos (α) sin (β)
y=L sin(α)
z=−L cos(α)cos(β) (1)

For given values of x, y, and z, the angles α and β can be computed as
α=sin⁻¹ (y/L)
β=tan⁻¹(x/z) (2)

Equations (1) and (2) hold true for the case when the axes of inclination angles are truly perpendicular. If γ is the angle between the two axes, the position of the end-effector can be expressed as
x=−LSγ((Cβ−1)CγSα+CαSβ)
y=L(CγCαSβ+Sα(C²γCβ+S²γ)) (3)
z=−L(CαCβ−CγSαSβ)

To solve equation (3) for the angles α and β when position of the end-effector is known, numerical techniques are used. Two additional kinematic parameters, namely, length of the link, L, and the angle between the measurement axes, γ, may be define for the identification.

Further, an equation of an algorithm for obtaining compensation is as follows.
du=J⁻¹dX (4)
where dX is the vector of residual errors, i.e. the cost function, and du is the vector for updating nominal values of the kinematic parameters that is used for compensation. Further, J is the identification Jacobian and is calculated for a set of postures of the end-effector using numerical techniques.

The cost function dX can be expressed in a number of ways. Computation of

Jacobian depends on the definition of the cost function.

For 5 DOF and 6 DOF motions, while data is measured such that the end-effector can be positioned over a spherical surface with arbitrary orientations, the cost function can be expressed as

$${dx}^{i} = [ \begin{matrix}{α}_{m}^{i} - {α}_{c}^{i} \\ {β}_{m}^{i} - {β}_{c}^{i} \\ {ϕ}_{m}^{i} - {ϕ}_{c}^{i}\end{matrix} ] ; dX = [ {dx}^{1} {dx}^{2} L {dx}^{M} ] \qquad ( 5 )$$

where the subscripts m and c indicate the measured and the computed values, respectively. For this case, the Jacobian J is computed as follows

$${j}^{′} = [ \begin{matrix}\frac{\partial {α}^{i}}{\partial {u}^{1}} & \frac{\partial {α}^{i}}{\partial {u}^{2}} & L & \frac{\partial {α}^{i}}{\partial {u}^{n}} \\ \frac{\partial {β}^{i}}{\partial {u}^{1}} & \frac{\partial {β}^{i}}{\partial {u}^{2}} & L & \frac{\partial {β}^{i}}{\partial {u}^{n}} \\ \frac{\partial {ϕ}^{i}}{\partial {u}^{1}} & \frac{\partial {ϕ}^{i}}{\partial {u}^{2}} & L & \frac{\partial {ϕ}^{i}}{\partial {u}^{n}}\end{matrix} ] ; J = [ \begin{matrix}{j}^{1} \\ {j}^{2} \\ M \\ {j}^{M}\end{matrix} ] \qquad ( 6 )$$
where n is the number of the kinematic parameters. Also, for this case, the cost function can also be established in terms of components of Cartesian posture x, y, and z as

$${dx}^{i} = [ \begin{matrix}\begin{matrix}{x}_{m}^{i} - {x}_{c}^{i} \\ {y}_{m}^{i} - {y}_{c}^{i} \\ {z}_{m}^{i} - {z}_{c}^{i}\end{matrix} \\ {ϕ}_{m}^{i} - {ϕ}_{c}^{i}\end{matrix} ] ; dX = [ {dx}^{1} {dx}^{2} L {dx}^{M} ] \qquad ( 5 )$$

The Jacobian J, then, given as

$${j}^{′} = [ \begin{matrix}\frac{\partial {x}^{i}}{\partial {u}^{1}} & \frac{\partial {x}^{i}}{\partial {u}^{2}} & L & \frac{\partial {x}^{i}}{\partial {u}^{n}} \\ \frac{\partial {y}^{i}}{\partial {u}^{1}} & \frac{\partial {y}^{i}}{\partial {u}^{2}} & L & \frac{\partial {y}^{i}}{\partial {u}^{n}} \\ \frac{\partial {y}^{i}}{\partial {u}^{1}} & \frac{\partial {z}^{i}}{\partial {u}^{2}} & L & \frac{\partial {z}^{i}}{\partial {u}^{n}} \\ \frac{\partial {ϕ}^{i}}{\partial {u}^{1}} & \frac{\partial {ϕ}^{i}}{\partial {u}^{2}} & L & \frac{\partial {ϕ}^{i}}{\partial {u}^{n}}\end{matrix} ] ; J = [ \begin{matrix}{j}^{1} \\ {j}^{2} \\ M \\ {j}^{M}\end{matrix} ] \qquad ( 6 )$$

Further, for this case, the cost function can also be established in terms of length of the constraint link as

$${dx}^{i} = [ \begin{matrix}L - {L}_{c}^{i} \\ {ϕ}_{m}^{i} - {ϕ}_{c}^{i}\end{matrix} ] ; dX = [ {dx}^{1} {dx}^{2} L {dx}^{M} ] \qquad ( 7 )$$

When LVDT is employed for measuring length of the link the cost function of equation (7) will change as

$${dx}^{i} = [ \begin{matrix}{L}_{m}^{i} - {L}_{c}^{i} \\ {ϕ}_{m}^{i} - {ϕ}_{c}^{i}\end{matrix} ] ; dX = [ {dx}^{1} {dx}^{2} L {dx}^{M} ] \qquad ( 8 )$$

The Jacobian J, for the cost functions of (7) and (8) is computed as

$${j}^{i} = [ \begin{matrix}\frac{\partial {L}^{i}}{\partial {u}^{1}} & \frac{\partial {L}^{i}}{\partial {u}^{2}} & L & \frac{\partial {L}^{i}}{\partial {u}^{n}} \\ \frac{\partial {ϕ}^{i}}{\partial {u}^{1}} & \frac{\partial {ϕ}^{i}}{\partial {u}^{2}} & L & \frac{\partial {ϕ}^{i}}{\partial {u}^{n}}\end{matrix} ] ; J = [ \begin{matrix}{j}^{1} \\ {j}^{2} \\ M \\ {j}^{M}\end{matrix} ] \qquad ( 9 )$$

For 3 DOF motions, while data is measured such that the position of the end-effector is fixed and its orientations can be arbitrary, the cost function can be expressed as

$$ⅆ {x}^{i} = [ \begin{matrix}{x}^{f} - {x}_{c}^{i} \\ {y}^{f} - {y}_{c}^{i} \\ {z}^{f} - {z}_{c}^{i} \\ {ϕ}_{m}^{i} - {ϕ}_{c}^{i}\end{matrix} ] ; ⅆ X = [ ⅆ {x}^{1} ⅆ {x}^{2} L ⅆ {x}^{M} ] \qquad ( 10 )$$

The Jacobian for this case can be computed as equation (6)

For a fixed position of the end-effector and for fixed length of the constraint link, respectively, the cost functions can also be expressed as a difference of computed values.

$$\begin{matrix}ⅆ {x}^{i , j} = [ \begin{matrix}{L}_{c}^{i} - {L}_{c}^{j} \\ {ϕ}_{m}^{i} - {ϕ}_{c}^{i}\end{matrix} ] ; i \neq j ; ⅆ X = [ ⅆ {x}^{1 , 2} ⅆ {x}^{, .3} L ⅆ {x}^{1 , M1} L ⅆ {x}^{M1 - 1 , M1} ] & ( 11 ) \\ ⅆ X = [ \begin{matrix}{x}_{c}^{i} - {x}_{c}^{j} \\ {y}_{c}^{i} - {y}_{c}^{j} \\ {z}_{c}^{i} - {z}_{c}^{j} \\ {ϕ}_{m}^{i} - {ϕ}_{c}^{j}\end{matrix} ] , i \neq j ; ⅆ X = [ ⅆ {x}^{1 , 2} ⅆ {x}^{1 , 3} L ⅆ {x}^{1 , M1} L ⅆ {x}^{M1 - 1 , M1} ] & ( 12 )\end{matrix}$$

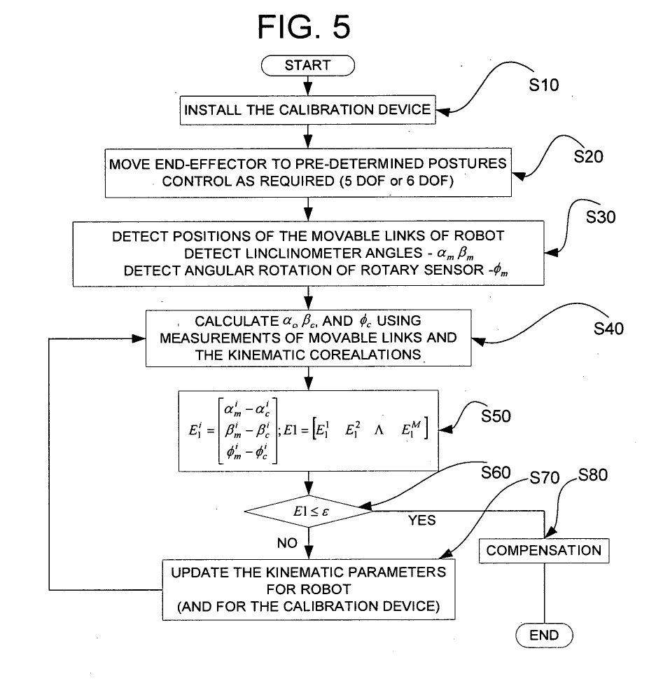

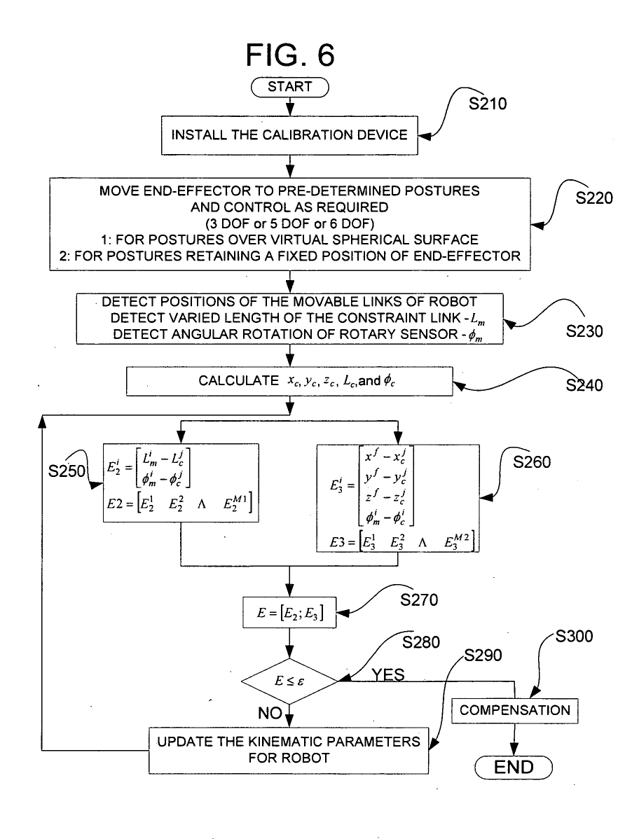

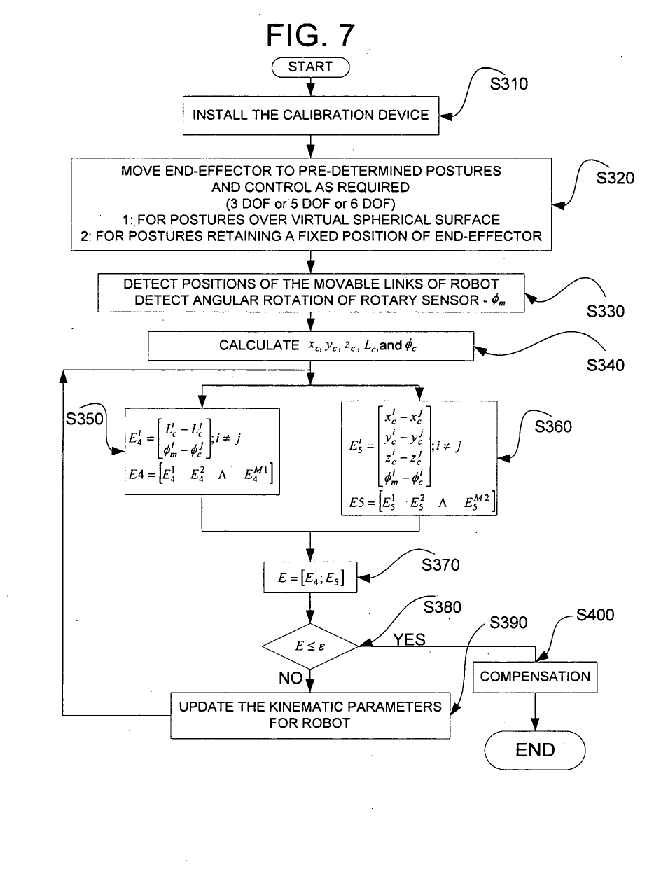

The robot 100 is calibrated using the appropriate cost function(s). This will be described below with reference to FIG. 5, FIG. 6 and FIG. 7.

First, as shown in FIGS. 1 5, 6, and 7, in order to calibrate the robot, the calibration device 10 is mounted on the robot 100 by fixing the supporting member 1 to the base 101 and fixing the rotational shaft 21 a of the rotary sensor 21 supported at the end of the constraint link 12 to the end-effector 105 so as to constrain the distance between the base 101 and the end-effector 105.

The distance between the base 101 and the end-effector 105 of the robot is determined according the length of the constraint link 12 used for constraining the distance between the base 101 and the end-effector 105 of the robot.

With the constraint of the distance between the base 101 and the end-effector 105 of the robot, the posture of the end-effector is controlled such that the end-effector can be positioned over a virtual spherical surface whose radius equals the length of the constraint link 12. Orientation of the end-effector can be arbitrary orientation (steps S20, S220, S320).

Further, as shown in FIG. 1 or 2, the position of the end-effector 105 of the robot can be fixed and the end-effector is then confined to only 3 DOF motions, i.e. it can have arbitrary orientation (steps S220, S320). Fixing the position can be achieved by using the means to detect inclination of the constraint link or by fitting the constraint post 18 around the end of the constraint link.

Steps S30, S230, and S330 of FIGS. 5, 6, and 7, respectively, refer to the measurement of the relevant values at each discrete posture of the end-effector. The positions of the 6 movable links 104, detected through internal sensors of the actuators 103, and the rotation angle φₘ of the end-effector 105 of the robot about the local z axis, detected through rotary sensor, are measured at each posture for all cases.

In steps S40, S240, and S340, of FIGS. 5, 6 and 7, the rotation angle φ_{c} of the end-effector 105 of the robot 100 is calculated through kinematic correlations using data on the positions of the movable links 104 detected in the respective postures of the end-effector 105. Values of α_{c}, β_{c}, L_{c}, x_{c}, y_{c}, and z_{c} are calculated, if required, through kinematic correlations using data on the positions of the movable links 104 detected in the respective postures of the end-effector 105.

In step S50 of FIG. 5, cost function is established, in terms of angles α, β and φ, as a difference of the values measured in S30 and the values calculated in S40. In step S250 of FIG. 6, cost function is established, in terms of L and φ, for postures measured over a virtual spherical surface, as a difference of the values measured in S230 and the values calculated in S240. In step S260 of FIG. 6, cost function is established, in terms of x, y, z, and φ, for postures measured with fixed position of the end-effector, as a difference of the values of measured in S330 and the values calculated in S340. Step S270 combines the cost functions of S250 and S260. In step S350 of FIG. 7, cost function is established, in terms L and φ, for postures measured over a virtual spherical surface, as a difference of the values of L for the i-th and the j-th postures as computed in S340. In step S360 of FIG. 7, cost function is established, in terms of length of x, y, z, φ, for postures measured with fixed position of the end-effector, as a difference of the values of x, y, and z for i-th posture and j-th postures as computed in S340. Step S370 combines the cost functions of S350 and S360

In steps S70, S280, and S380 of FIGS. 5, 6, and 7, respectively, cost function is compared with a predefined tolerance. If the cost function does not satisfy the tolerance bound, compensation for kinematic parameters is computed based on the kinematic correlations and using the values of the cost function. The steps of calculations are repeated till the cost function falls in the tolerance bound. Compensation is performed as the last step of calibration, refer to S80, S300, and S400 of FIGS. 5, 6, and 7, respectively. S70 in the FIG. 5 may include kinematic parameters of the calibration device in addition to the kinematic parameters of the robot.

The device and method for kinematic calibration of the robot according to the present invention offers all the advantages that are associated with the calibration of robot manipulators, a few of which can be counted as

First, with the kinematic calibration, the accuracy of position and orientation can be improved about as much as 10 times as compared with the accuracy before calibration is performed.

Second, since the robot can be periodically calibrated upon reduction of the accuracy due to wear of parts and upon repair, the accuracy can be maintained.

Third, the present invention can help application of computer integrated manufacturing using off-line programming.

In addition to the general benefits, the present invention utilizes gadgets, already known for calibration of robot manipulators, in such a fashion that all kinematic parameters of a robot can be identified with partial measurement of postures. This increases the reliability of calibration results and assures uniform accuracy in the work space of a robot.

Although the present invention has been described in connection with the embodiments illustrated in the accompanying drawings, it is merely illustrative. It will be understood by those skilled in the art that various modifications and equivalent embodiments can be made thereto without departing from the scope of the present invention.

Therefore, the true scope of the present invention should be defined only by the appended claims.

1. A device for kinematic calibration of a robot, comprising:
a supporting member fixed to a base of the robot;
a constraint link installed between the supporting member and the end-effector of a robot connected to the base of the robot through a plurality of movable links so as to constrain a distance between the base and the end-effector of the robot;
two joints installed on the constraint link;
a mean installed on the constraint link for detecting angular rotation of the end-effector when the end-effector moves to a pre-determined posture; and
a mean installed on the constraint link to detect inclination of the constraint link about two mutually perpendicular axes.

2. The device as claimed in claim 1, wherein the constraint link is further provided with a length varying means for varying the length of the constraint link.

3. The device as claimed in claim 1, further comprising a mean to measure length for measuring the varied length of the constraint link when the end-effector of the robot moves to a pre-determined posture.

4. The device as claimed in claim 1, wherein the mean to detect angular rotation comprises a rotary sensor installed between an end of the constraint link and the end-effector.

5. The device as claimed in claim 4, wherein the rotary sensor is supported by a housing installed at the end of the constraint link, and a rotational shaft of the rotary sensor is connected to a rotational shaft of the end-effector.

6. The device as claimed in claim 1, wherein the base is provided with a constraint post for supporting the constraint link so that an upper portion of the constraint link can be kept fixed vertically.

7. A method for kinematic calibration of a robot, comprising the steps of:
installing a constraint link between the base and the end-effector of a robot to constrain a distance therebetween, the constraint link having a mean to detect inclination about two mutually perpendicular axes for measuring inclination of the constraint link about X and Y axes, a mean to detect angular rotation for measuring angular rotation of the end-effector about local z-axis, and two joints installed thereon;
measuring the inclination angles αₘ and βₘ of the constraint link about X and Y axes, the angular rotation φₘ of the end-effector about the local z-axis, and the lengths of the moveable links for a plurality of pre-determined postures, and calculating inclination angles α_{c} and β_{c} about X and Y axes and the angular rotation φ_{c} of the end-effector about the local z-axis at the measured postures, and defining residual errors (cost function) as a difference of the measured and the computed values as given in the equation:
$${E}_{1}^{i} = [ \begin{matrix}{α}_{m}^{i} - {α}_{c}^{i} \\ {β}_{m}^{i} - {β}_{c}^{i} \\ {ϕ}_{m}^{i} - {ϕ}_{c}^{i}\end{matrix} ] , E1 = [ {E}_{1}^{1} , {E}_{1}^{2} , L , {E}_{1}^{M} ] ;$$
determining the amount of compensation for the kinematic parameters according to the correlations between the kinematic parameters and the postures of the robot if the residual errors, ‘E1’, do not satisfy a predefined value, ε, and calibrating the robot based on the amount of compensation calculated.

8. A method for kinematic calibration of a robot, comprising the steps of:
installing a constraint link between the base and the end-effector of a robot to constrain a distance therebetween, the constraint link having a mean to detect inclination about two mutually perpendicular axes for measuring inclination of the constraint link about X and Y axes, a mean to detect angular rotation for measuring the angular rotation of the end-effector about the local z-axis, a mean to detect variation in length for measuring the variation in the length of the constraint link, and two joints installed thereon;
measuring the length of the constraint link Lₘ, the angular rotation φₘ of the end-effector about the local z-axis, and the lengths of the moveable links for a plurality of pre-determined postures such that the end-effector is positioned over a virtual spherical surface,
measuring the angular rotation Lₘ, of the end-effector about the local z-axis, and the lengths of the moveable links for a plurality of pre-determined postures such that position of the end-effector is fixed, calculating the length of the constraint link L_{c}, and the angular rotation Φ_{c} of the end-effector about the local z-axis for measured postures where the end-effector is positioned over a virtual spherical surface, calculating position components of the end-effector x_{c}, y_{c}, z_{c} and the angular rotation φ_{c} of the end-effector about the local z-axis for measured postures where position of the end-effector is fixed, defining residual errors, ‘E2’, for measured postures where the end-effector is positioned over a virtual spherical surface, as the following equation:
$${E}_{2}^{i} = [ \begin{matrix}{L}_{m}^{i} - {L}_{c}^{i} \\ {ϕ}_{m}^{i} - {ϕ}_{c}^{i}\end{matrix} ] , E2 = [ {E}_{2}^{1} , {E}_{2}^{2} , L , {E}_{2}^{M1} ]$$
where Lₘ and L_{c} refer to the measured and the computed length of the constraint link, respectively, Lₘ replaced by L for the case when the length of the constraint link is fixed and does not have mean to detect the variation of the constraint link, and defining residual errors ‘E3’, for measured postures where position of the end-effector is fixed, as the following equation:
$${E}_{3}^{i} = [ \begin{matrix}{x}^{f} - {x}_{c}^{i} \\ {y}^{f} - {y}_{c}^{i} \\ {z}^{f} - {z}_{c}^{i} \\ {ϕ}_{m}^{i} - {ϕ}_{c}^{j}\end{matrix} ] , E3 = [ {E}_{3}^{1} , {E}_{3}^{2} , L , {E}_{3}^{M2} ]$$
where x_{c}, y_{c}, and z_{c} refer to the position components of the end-effector calculated using the measurements of the movable links and the kinematic correlations;
determining the amount of compensation for the robot according to the correlations between the kinematic parameters and the postures of the robot if the residual errors, ‘E2’ or the residual errors ‘E3’ do not satisfy a predefined value, ε, and calibrating the robot based on the amount of compensation calculated.

9. A method for kinematic calibration of a robot, comprising the steps of:
installing a constraint link between the base and the end-effector of a robot to constrain a distance therebetween, the constraint link having a mean to detect inclinations for measuring inclination of the constraint link about two mutually perpendicular axes, a mean to detect angular rotation of the end-effector, and two joints installed thereon;
measuring the angular rotation φₘ of the end-effector about the local z-axis, and the lengths of the moveable links for a plurality of pre-determined postures such that the end-effector is positioned over a virtual spherical surface, measuring the angular rotation φₘ of the end-effector about the local z-axis, and the lengths of the moveable links for a plurality of pre-determined postures such that position of the end-effector is fixed, calculating the length of the constraint link L_{c}, and the angular rotation φ_{c} of the end-effector about the local z-axis for measured postures where the end-effector is positioned over a virtual spherical surface, calculating position components of the end-effector x_{c}, y_{c}, z_{c} and the angular rotation φ_{c} of the end-effector about the local z-axis for measured postures where position of the end-effector is fixed, defining residual errors, ‘E₄’, for measured postures where the end-effector is positioned over a virtual spherical surface, as the following equation:
$${E}_{4}^{i} = [ \begin{matrix}{L}_{c}^{i} - {L}_{c}^{j} \\ {ϕ}_{m}^{i} - {ϕ}_{c}^{i}\end{matrix} ] j \neq k , E4 = [ {E}_{4}^{1} , {E}_{4}^{2} , L , {E}_{4}^{M1} ]$$
where i and j refer to the i-th and j-th measured posture, and defining residual errors ‘E5’, for measured postures where position of the end-effector is fixed, as the following equation:
$${E}_{4}^{i} = [ \begin{matrix}{x}_{c}^{i} - {x}_{c}^{j} \\ {y}_{c}^{i} - {y}_{c}^{j} \\ {z}_{c}^{i} - {z}_{c}^{j} \\ {ϕ}_{m}^{i} - {ϕ}_{c}^{j}\end{matrix} ] ; i \neq j , E5 = [ {E}_{5}^{1} , {E}_{5}^{2} , L , {E}_{5}^{M2} ] ;$$
determining the amount of compensation for the robot according to the correlations between the kinematic parameters and the postures of the robot if the residual errors, ‘E4’ or the residual errors ‘E5’ does not satisfy a predefined value, ε, and calibrating the robot based on the amount of compensation
